(19) United States
(12) Patent Application Publication
(10) Pub. No.: US 2025/0146862 A1
(43) Pub. Date: May 8, 2025

(54) CABLE NETWORK INSPECTION USING OPTICAL FIBER SENSING

(71) Applicant: NEC Laboratories America, Inc., Princeton, NJ (US)

(72) Inventors: Ming-Fang Huang, Princeton, NJ (US); Ting Wang, West Windsor, NJ (US)

(21) Appl. No.: 18/924,340

(22) Filed: Oct. 23, 2024

Related U.S. Application Data
(60) Provisional application No. 63/596,700, filed on Nov. 7, 2023.

(51) Int. Cl. G01H 9/00; G01D 5/353; H04B 10/079

(52) U.S. Cl. CPC G01H 9/004; G01D 5/35364; H04B 10/0791; H04B 10/0793

(57) ABSTRACT

Systems and methods for cable inspection using optical fiber sensing includes a hardware processor and a memory storing a computer program which, when executed by the hardware processor, causes the hardware processor to collect data from a fiber optic cable and analyze the data with a distributed fiber optic sensing (DFOS) system. Losses and anomalies and their locations are identified in the cable. An alert is generated based on the losses and anomalies.

### RELATED APPLICATION INFORMATION

This application claims priority to U.S. Provisional Patent Application No. 63/596,700 filed on Nov. 7, 2023, incorporated herein by reference in its entirety.

### BACKGROUND

### Technical Field

The present invention relates to optical fiber sensing, and more particularly, systems and methods that monitor optical fiber installation to evaluate handling and other risks.

### Description of the Related Art

As the demand for broadband access networks continues to increase, driven by the ever-increasing need for data and future network advancements, telecom carriers have undertaken substantial fiber infrastructure projects. These endeavors are geared towards accommodating exponential growth in Internet traffic and ensuring the seamless operation of next-generation telecommunications networks. Consequently, an upsurge in cable installation projects looms on the horizon, reflecting the industry's proactive stance in meeting these burgeoning connectivity needs.

However, this surge in cable installation brings with it a pressing need to ensure the pristine condition of communication lines. Delivering dependable and comprehensive results concerning cable conditions both before and after installation is needed. Cable installation inspection relies on Optical Time Domain Reflectometers (OTDRs), which have inherent limitations. While OTDRs are invaluable tools for assessing post-installation cable insertion loss, they lack the capability to provide precise geographic location information. This deficiency becomes particularly evident when encountering issues such as high loss points in buried conduit installations. In such scenarios, the absence of location data poses significant hurdles in identifying the exact position of potential cable damage or faults, rendering the prospect of reinstallation a daunting and costly endeavor.

### SUMMARY

According to an aspect of the present invention, systems and methods for cable inspection using optical fiber sensing include a hardware processor and a memory storing a computer program which, when executed by the hardware processor, causes the hardware processor to collect data from a fiber optic cable and analyze the data with a distributed fiber optic sensing (DFOS) system. Losses and anomalies and their locations are identified in the cable. An alert is generated based on the losses and anomalies.

The systems and methods can employ machine learning that includes a neural network trained to recognize specific patterns associated with cable degradation. The neural network can be trained on a dataset that includes different types of fiber losses and failure modes. The machine learning can predict future losses and anomalies in the cable. A computer program can cause the hardware processor to graphically display the losses and anomalies on a cable. In an embodiment, the computer program can display cable images graphically showing the losses and anomalies overlaid on an image of the cable.

According to another aspect of the present invention, a system for cable network inspection using optical fiber sensing includes a distributed fiber optic sensing (DFOS) system configured to collect data about a cable network. The system also includes a hardware processor and a memory storing a computer program which, when executed by the hardware processor, causes the hardware processor to receive data from the DFOS system, process the received data to identify potential issues or anomalies and their locations in the cable network, and generate alerts based on the processed data.

According to other aspects of the present disclosure, the system may include one or more of the following features. The DFOS system may comprise at least one of a Distributed Acoustic Sensing (DAS) system, a Distributed Vibration Sensing (DVS) system, and a Brillouin Optical Time Domain Reflectometry (BOTDR) system. The computer program may further cause the hardware processor to display the processed data and the generated alerts on a user interface. The computer program may further cause the hardware processor to update a database with the processed data and the generated alerts. The potential issues or anomalies may comprise at least one of cable loss, cable strain, and high-risk positions. The computer program may further cause the hardware processor to provide real-time guidance to field technicians based on the identified potential issues or anomalies. The real-time guidance may comprise instructions for cable rerouting when high-risk positions are detected.

According to another aspect of the present disclosure, a computer-implemented method for cable network inspection using optical fiber sensing is provided. The method includes collecting data from a fiber optic cable; analyzing the data with a distributed fiber optic sensing (DFOS) system; identifying losses and anomalies and their locations in the cable; and generating alerts based on the losses and anomalies.

According to other aspects of the present disclosure, the method may include one or more of the following features. The DFOS system may comprise at least one of a Distributed Acoustic Sensing (DAS) system, a Distributed Vibration Sensing (DVS) system, and a Brillouin Optical Time Domain Reflectometry (BOTDR) system. The method may further comprise displaying the processed data and the generated alerts on a user interface. The method may further comprise updating a database with the processed data and the generated alerts. The potential issues or anomalies may comprise at least one of cable loss, cable strain, and high-risk positions. The method may further comprise providing real-time guidance to field technicians based on the identified potential issues or anomalies and their locations. The real-time guidance may comprise instructions for cable rerouting when high-risk positions are detected.

According to another aspect of the present disclosure, a non-transitory computer-readable storage medium storing instructions is provided. When executed by a processor, the instructions cause the processor to perform a method for cable network inspection using optical fiber sensing. The method includes receiving data from a distributed fiber optic sensing (DFOS) system about a cable network, analyzing the received data to detect potential issues or anomalies and their locations in the cable network, and generating alerts based on the detected potential issues or anomalies.

According to other aspects of the present disclosure, the non-transitory computer-readable storage medium may include one or more of the following features. The DFOS system may comprise at least one of a Distributed Acoustic Sensing (DAS) system, a Distributed Vibration Sensing (DVS) system, and a Brillouin Optical Time Domain Reflectometry (BOTDR) system. The method may further comprise displaying the analyzed data and the generated alerts on a user interface. The potential issues or anomalies may comprise at least one of cable loss, cable strain, and high-risk positions. The method may further comprise providing real-time guidance to field technicians based on the detected potential issues or anomalies and their locations. The real-time guidance may comprise instructions for cable rerouting when high-risk positions are detected.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a system/method for inspecting and monitoring a fiber optic cable, in accordance with an embodiment of the present invention;

FIG. 2 is a schematic diagram illustrating a system/method for inspecting and monitoring a fiber optic cable before starting a cable installation, through installation and future assessment, in accordance with an embodiment of the present invention;

FIG. 3 is a diagram showing depiction of cables over time to monitor degradation, in accordance with an embodiment of the present invention;

FIG. 4 is a block/flow diagram showing a computer system for inspecting and monitoring a fiber optic cable including DFOS and a machine learning (AI) system, in accordance with an embodiment of the present invention; and

FIG. 5 is a block/flow diagram showing systems and computer-implemented methods for cable inspection and monitoring using optical fiber sensing, in accordance with an embodiment of the present invention.

### DETAILED DESCRIPTION OF PREFERRED EMBODIMENTS

In accordance with embodiments of the present invention, systems and methods are described that can be used for comprehensive cable installation inspection solutions that leverage distributed fiber optic sensing (DFOS) systems and a generative artificial intelligence (AI) based system. Real-time monitoring of cable conditions before, during, and after installation is provided ensuring cable integrity and minimizing the risk of damage. Some features include cable loss monitoring, strain monitoring, and an AI alert system that promptly notifies technicians of high-risk positions. The systems offer precise location data for potential cable damage or faults, addressing limitations of current Optical Time Domain Reflectometer (OTDR)-based approaches. By enabling proactive maintenance and efficient repairs, the present solution enhances the reliability and longevity of communication networks, ultimately improving the resilience of cable installations for telecommunication carriers, cable owners and others.

In accordance with embodiments of the present invention, cable inspection systems can leverage generative AI-based algorithms and distributed fiber optic sensing (DFOS) systems to allow for real-time monitoring of cables, not only during installation but also before and after, offering a comprehensive assessment of a condition of the cable. This ensures that cable installation proceeds without undue tension, minimizing the risk of damage and enhancing reliability. Carriers and cable owners can effectively maintain the exceptional quality of their fiber cable installations, thereby bolstering the resilience and longevity of communication networks.

The present invention provides systems and methods for inspecting cable networks using optical fiber sensing. These systems and methods may include cable loss monitoring, strain monitoring, and an AI alert system that promptly notifies technicians of high-risk positions. These systems and methods can offer precise location data for potential cable damage or faults, addressing limitations of current OTDR-based approaches.

In some embodiments, the systems and methods may include a pre-installation assessment, real-time monitoring during installation, and a post-installation inspection. These stages may involve various processes such as cable condition assessment, real-time guidance to field technicians, ongoing monitoring during installation, immediate action upon detection of high-risk positions, and anomaly detection of surrounding environments post-installation. The systems and methods disclosed herein provide real-time monitoring, precise location data, comprehensive coverage, reduced downtime, enhanced reliability, efficient maintenance, improved safety, scalability, reduced maintenance costs, and enhanced cable lifespan.

In some embodiments, the systems and methods may involve the use of a hardware processor subsystem and a memory that stores a computer program. When executed by the hardware processor, the computer program may cause the hardware processor to perform various functions related to cable network inspection using optical fiber sensing. In some cases, a computer-implemented method can involve receiving data from a distributed fiber optic sensing (DFOS) system. This data may include information about the condition of cables in a network, such as strain data, temperature data, or other relevant parameters.

In some aspects, the methods may further involve processing the received data to identify potential issues or anomalies in the cable network. This processing may be performed by the hardware processor executing the computer program stored in the memory. The processing may involve applying machine learning algorithms or other data analysis techniques to the received data.

The methods may also involve generating alerts based on the processed data. These alerts may be sent to technicians or other relevant parties to notify them of potential issues or anomalies in the cable network. The alerts may include information about the location and nature of the potential issues or anomalies, thereby enabling prompt and targeted response. A database can be updated with the processed data and the generated alerts. This database may be used for historical analysis, trend identification, predictive maintenance, or other purposes. The processed data and the generated alerts can be displayed on a user interface. This user interface may provide a visual representation of the cable network and the identified issues or anomalies, thereby facilitating understanding and decision-making.

In some cases, the method may also involve communicating with other systems or devices in the cable network. This communication may involve sending commands, receiving data, exchanging information, or performing other communication actions.

In some aspects, the computer-implemented method may include a pre-installation assessment process. This process may involve setting up the system, connecting the system to the cable network, and evaluating the initial condition of the cables. The setup may involve installing the hardware processor and the memory, loading the computer program into the memory, configuring the DFOS system, or performing other setup actions. The connection may involve connecting the system to the cable network, establishing communication links with other systems or devices in the network, or performing other connection actions. The initial cable condition evaluation may involve receiving data from the DFOS system, processing this data to assess the condition of the cables, or performing other evaluation actions.

In some aspects, the systems and methods for inspecting cable networks using optical fiber sensing may include a post-installation inspection process. This process may involve a hardware processor and a memory that stores a computer program. When executed by the hardware processor, the computer program may cause the hardware processor to perform specific operations related to post-installation inspection.

For instance, the post-installation inspection process may involve anomaly detection. This anomaly detection may be facilitated by the hardware processor executing the computer program. The anomaly detection may involve analyzing the data received from the DFOS system, identifying patterns or anomalies that may indicate potential issues or faults in the cable network, and generating alerts based on the identified anomalies.

In some cases, the post-installation inspection process may also involve long-term monitoring strategies. These strategies may be implemented by the hardware processor executing the computer program. The long-term monitoring strategies may involve continuously receiving data from the DFOS system, periodically analyzing this data to detect any changes or trends that may indicate potential issues or faults, and updating a database with the received data and the results of the analysis.

In some aspects, the system may further comprise a display device. This display device may be controlled by the hardware processor executing the computer program. The hardware processor may cause the display device to display a graphical user interface. This graphical user interface may provide a visual representation of the cable network, the identified anomalies, the results of the long-term monitoring, or other relevant information.

In some cases, the graphical user interface may also provide interactive features. These features may allow a user to view detailed information about the anomalies, adjust the parameters of the anomaly detection or the long-term monitoring, initiate additional inspections or repairs, or perform other actions.

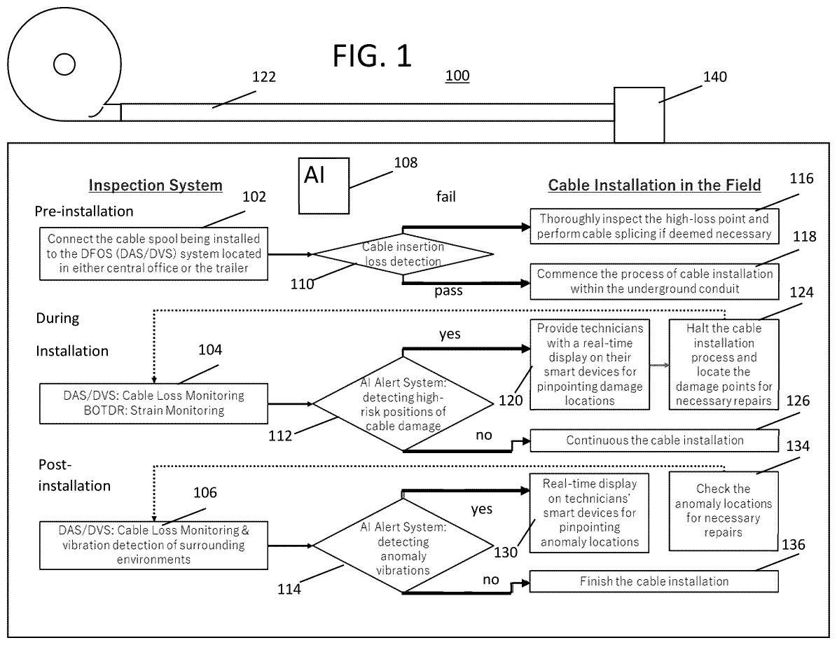

Referring now in detail to the figures in which like-numerals represent the same or similar elements and initially to FIG. 1, a block/flow diagram showing a system/method 100 for monitoring a cable 122 before, during and after installation is shown and described in accordance with embodiments of the present invention. The system/method 100 includes a pre-inspection component 102, a cable installation component 104 and a post-inspection component 106. Each component 102, 104, 106 includes or can access a cable inspection generative AI-based algorithm 108 designed to autonomously identify potential cable damage along a route during cable installation. The pre-inspection (or installation) component 102 includes a DAS or DVS cable loss monitoring feature 110. To ensure cable integrity, monitoring is conducted to detect any undesired insertion loss along the cable 122. If the cable insertion loss detection test fails, the cable is thoroughly inspected at the high-loss points and cable splicing or other remial actions can be performed, in block 116. If the cable insertion loss test passes, then cable installation can proceed in block 118.

During installation, the cable installation component 104 can execute a real-time interactive method in block 112 to determine whether high-risk positions are present in the cable 122 and, if so, provide real-time guidance to field technicians or others, in block 120, thereby ensuring efficient and effective cable installation. Cable loss monitoring can be provided during installation in block 112 to verify the cable's condition, ensuring there is no undue signal attenuation along its length. Strain monitoring ensures that the cable is not subjected to excessive tension during installation. An AI alert system in block 112 is provided to detect high-risk positions of the cable. An AI engine in block 112 promptly alerts field technicians, allowing for immediate cable rerouting. The technicians can review the cable status and pinpoint positions on their smart devices or computers. in block 120. In the event, that failures occur, a halt mechanism in block 124 can be activated that stops the installation process and locates damage points to enable repairs. If no high-risk information is generated in block 112, the cable installation can continue in block 126.

A post-inspection component 106 provides continuous monitoring post-installation to confirm the cable's condition, ensuring there is no additional insertion loss after installation. In block 114, the post-installation component 106 monitors vibration to newly deployed cables, enabling the detection of any anomalous events that may pose a threat to cable integrity. In case of anomalous events, the technicians can review the cable status and pinpointed positions on their smart devices or computers in block 130. In the event, that failures occur, anomalies are pinpointed in block 134 to locate damage points to enable repairs. If no high-risk information is generated in block 112, the cable installation can continue in block 136.

A fiber optic interrogation system 140 is connected to the cable 122. The interrogation system in block 120 employs a distributed fiber optic sensing (DFOS) technology, such as Distributed Acoustic Sensing (DAS), Distributed Vibration Sensing (DVS), Brillouin Optical Time Domain Reflectometry (BOTDR), etc. These technologies may provide various advantages, such as high sensitivity, wide coverage, real-time monitoring, or other advantages.

In some cases, the DAS technology may be used to detect and measure acoustic signals in the cable 122. These acoustic signals may be caused by various events, such as cable movement, cable vibration, cable strain, cable bending, or other events. The DAS technology may provide high sensitivity, wide coverage, real-time monitoring, as well other advantages. In some cases, the BOTDR technology may be used to detect and measure temperature and strain in the cable network. These temperature and strain measurements may be used to assess the condition of the cables, detect potential issues or faults, or perform other assessments. The BOTDR technology may provide high sensitivity, wide coverage, real-time monitoring, and/or other advantages.

The fiber optic interrogation system 140 can include a computer system which interprets fibers optic changes imparted to light signals as a result of cable movement, cable vibration, cable strain, cable bending, or other events. The fiber optic interrogation system 140 permits real-time monitoring at every stage of the cable's deployment and operation. Fiber sensing technology provides continuous, real-time monitoring of the cable's condition, allowing for immediate detection of issues or anomalies.

The issues or anomalies can be precisely located since fiber sensing can pinpoint the exact location of cable damage or high-loss points, facilitating quicker and more accurate repairs. The cable 122 can be comprehensively covered along the entire cable length, ensuring that no section is left uninspected. Quick detection and location of cable damage means shorter downtime for repairs and minimizing service interruptions. Reliability is improved with continuous monitoring, which enhances cable network reliability by identifying potential problems before they escalate. Proactive maintenance is enabled by reducing the need for reactive, emergency repairs.

The use of fiber sensing reduces the need for manual inspections in potentially hazardous environments, enhancing technician safety. Fiber sensing technology can be scaled to monitor multiple cables or an entire network, making it suitable for various infrastructure sizes. Proactive maintenance based on fiber sensing data can lead to cost savings over time by avoiding unnecessary repairs. Timely identification and mitigation of issues can also extend the lifespan of the cable infrastructure.

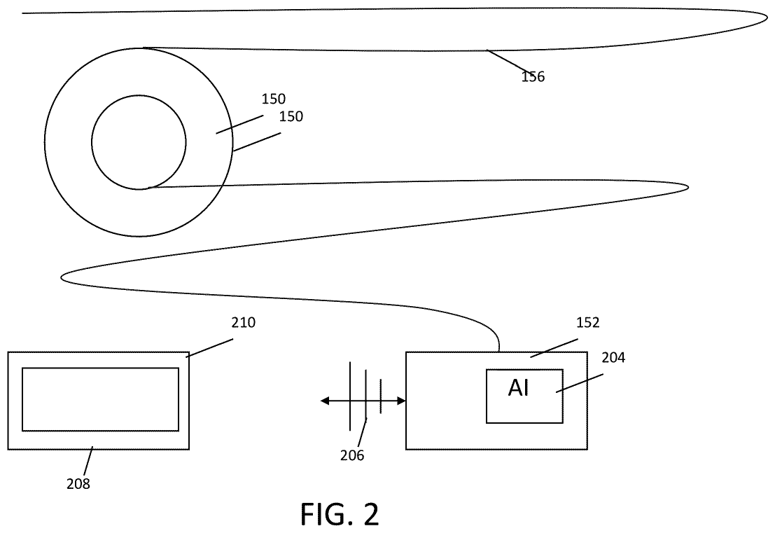

Referring to FIG. 2, before starting a cable installation, a thorough pre-installation assessment can be conducted to monitor the cable's initial condition to ensure the cable is in good shape with no excessive insertion loss. A cable spool 150 can be connected to a DFOS system 152 located in a central office, a trailer or other site. The DFOS system 152 can be DAS, DVS or other system. Insertion loss of a cable 156 can be measured to ensure there is no additional loss on the cable spool 150. If any extra loss is detected, repairs can be performed before proceeding with the installation.

The cable installation process can begin. The installation can be above or below ground, and the installation can be within a conduit, preform or other designated route. In an embodiment, the cable can be deployed from a cable ship. As the cable 156 is being deployed DAS and/or DVS can be employed for real-time cable loss monitoring, alongside BOTDR for precise cable strain detection.

An AI system 204 can be employed to assess damage points within the cable. The AI system 204 can maintain continuous monitoring for high-loss points or anomalies in cable strain along the designated cable route. The AI system 204 can identify risk patterns and can identify areas at high risk of damage. Technicians can receive real-time alerts output from the AI system 204. An alert system 206 is activated as part of the real-time monitoring to alert, e.g., devices 208 used by technicians or others involved in the installation, such as smart phones, laptops, or other wired or wireless devices. Audible and visual alarms can also be employed. This can provide technicians with a live view of the cable's status and any potential issues as the cable is being installed. Alerts can be generated on a user interface 210 of the device or devices 208. The user interface 210 can include a graphical user interface but any form of rendering the alert can be employed (e.g., visual, sound, etc.).

The AI system 204 can be implemented as a part of the computer program stored in memory and executed by a hardware processor. The AI system 204 can include algorithms, models, or techniques that are designed to analyze the data received from the DFOS system, identify patterns or anomalies in the data, generate alerts based on the identified patterns or anomalies, or perform other AI tasks.

The AI system 204 can include a neural network architecture. This architecture may be a feedforward neural network, a convolutional neural network, a recurrent neural network, a deep neural network, or any other type of neural network architecture. The neural network architecture may be designed to process the data received from the DFOS system, learn from this data, make predictions based on this data, or perform other neural network operations.

The neural network architecture may be trained using a training process that includes presenting the neural network with a set of training data, adjusting the weights and biases of the neural network based on the error between the neural network's output and the desired output, iterating this process until the neural network's performance reaches a satisfactory level, or performing other training operations. The training data may include historical data from the cable network, simulated data, labeled data, or other types of data. The AI system 204 can be trained to decipher failure modes or loss patterns and output an alert in accordance with recognized failure or loss patterns.

In some aspects, the AI system may recognize specific patterns associated with lossy fiber sections and various failure modes in cable networks. This pattern recognition capability may enhance the system's ability to detect and classify potential issues accurately.

The AI system 204 may be trained on a diverse dataset that includes examples of different types of fiber losses and failure modes. This dataset may include simulated data, historical data from real-world cable installations, and expert-labeled data highlighting specific issues. By exposing the AI system 204 to this comprehensive dataset, it may learn to identify subtle patterns that indicate current and/or potential problems and their distance along the cable.

In some cases, the AI system 204 may employ advanced signal processing techniques to preprocess the raw data from the DFOS system. This preprocessing may involve noise reduction, feature extraction, and signal normalization, which may help highlight relevant patterns, improve the AI system's detection accuracy and assist in accurately pinpointing here issues occur.

The pattern recognition capabilities of the AI system 204 may extend to identifying various types of fiber losses, such as bending losses, splice losses, and connector losses. Each of these loss types may have distinct signatures in the DFOS data, which the AI system 204 may learn to recognize and differentiate.

For failure mode detection, the AI system may be trained to identify patterns associated with different types of cable damage or degradation. This may include recognizing patterns indicative of physical stress, environmental factors, or installation-related issues. For example, the system may learn to identify patterns associated with excessive bending, crushing, or stretching of the cable.

In some implementations, the AI system 204 may utilize a combination of supervised and unsupervised learning techniques. Supervised learning may be used to train the system on known patterns of lossy sections and failure modes, while unsupervised learning techniques may help the system discover new, previously unknown patterns that may indicate potential issues.

The AI system 204 may also incorporate temporal analysis capabilities, allowing it to detect patterns that evolve over time. This may be particularly useful for identifying gradual degradation of the cable or predicting potential failures before they occur.

In some aspects, the system may employ ensemble learning techniques, combining multiple AI models to improve overall pattern recognition accuracy. Each model in the ensemble may specialize in detecting specific types of patterns or failure modes, with the final decision being made based on a combination of their outputs.

The pattern recognition capabilities of the AI system 204 may be continuously refined through ongoing learning. As new data is collected and analyzed, the AI system 204 may update its knowledge base, improving its ability to recognize both common and rare patterns associated with lossy fiber sections and failure modes.

The AI system 204 can be trained on different cable types and installation features or structures such that the AI system 204 is knowledgeable of varying components, requirements and scenarios of the cable network. The alerts output from the AI system 204 can be customized.

Upon receiving alerts, technicians or others can stop the cable installation process. The real-time data and the DFOS system can be employed to precisely locate the damage points or high-loss areas. If necessary, technicians can perform cable splicing or repair work on a timely basis to reduce downtime. Once the damage points are located and identified, technicians can proceed with the necessary repairs or corrective actions. This ensures that the cable installation continues with optimal integrity. After addressing the damage points and ensuring the cable's integrity using the fiber sensing system 152, the cable installation can be resumed.

After the cable installation, a thorough post-installation assessment can be conducted using the fiber sensing system 152. The cable's condition can be continually monitored to ensure the cable remains in good shape.

The AI system 204 can be employed for anomaly detection along the length of the cable 156 to not only detect potential weakness in the cable 156, but also to access surrounding environments. As an example, a buried cable may stretch across a high traffic area and strain readings and vibration readings show an elevated strain region due to comparison of the cable due to pedestrian or vehicle traffic. The cable can be monitored over time to evaluate the cable after installation to verify that there is no additional insertion loss, but also measure parameters to evaluate future damage, e.g., due to the high traffic impact. In this way, vibration monitoring on the newly deployed cable can be employed to detect any anomalies that may cause cable damage in the future.

Data can be collected, stored and analyzed during the installation and monitoring processes. The data can be employed to further train the AI system 204, and/or provide a detailed report on a state of a cable, cable system, network, etc. Comprehensive reports can be generated detailing the cable's condition, any repairs made, and the overall quality of the installation. A graphical image or depiction can be generated that shows the entire cable length (e.g., the cable portions can be compressed or scaled down for readability and quick reference) and shows its current status or its status at any time in the past or a predicted status in the future. Such images can be useful for maintenance and long-term monitoring as changes between image over time can provide a convenient way to quickly review a cable and compare its status to prior images. Long-term monitoring strategies can be implemented to ensure the continued health and performance of the installed cable. These reports and images can be regularly reviewed and analyzed to proactively address any emerging issues.

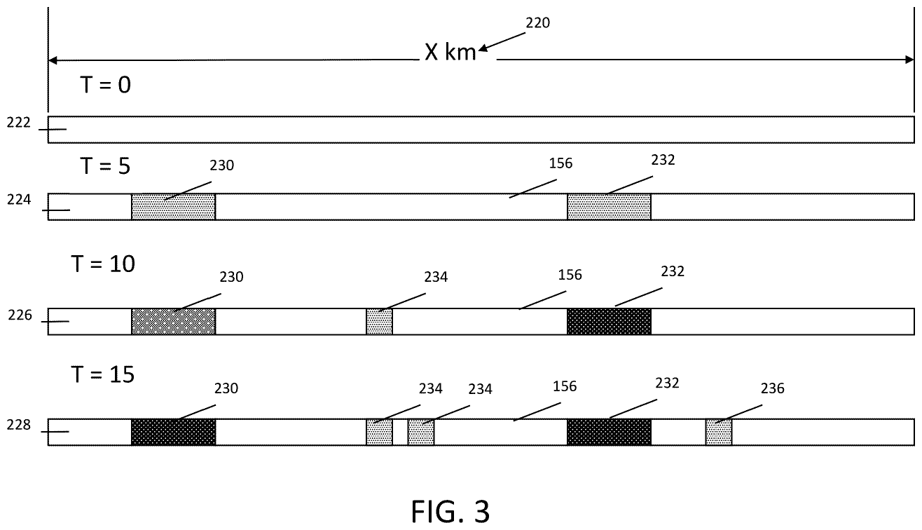

Referring to FIG. 3, graphical images generated by the system 152 provide cable lengths 220 (e.g., X km) illustratively showing cable status over time. Images 222, 224, 226, 228 show the cable 156 at time (T): T=0, T=5, T=10, T=15, respectively. The images can be generated by the system based on measurements made over time. In the example, regions of interest 230, 232, 234, and 236 can indicate strains, defects or losses that can develop over time. Changes between images over time can provide a convenient way to quickly review a cable and compare its status to prior images. Long-term monitoring strategies can be implemented to ensure the continued health and performance of the installed cable 156. These reports and images can be regularly reviewed and analyzed to proactively address any emerging issues.

In some aspects, image comparisons of cables can be generated to aid in the analysis and monitoring process. These image comparisons may provide visual representations of cable conditions at different points in time or under different circumstances. For example, side-by-side comparisons of cable images taken before and after installation, or before and after a repair operation can be generated. These comparisons may help technicians and engineers quickly identify changes in cable condition, potential damage, or areas of concern.

The image comparisons may include various types of visual data, such as thermal imaging to detect hot spots or areas of unusual temperature, high-resolution photographs to show physical damage or wear, or graphical representations of data collected by the DFOS system 152. In some cases, data from the DFOS system can be overlaid onto visual images of the cable 156, creating a comprehensive visual representation of the cable's condition. A series of images taken at regular intervals may show the gradual development of strain or stress in a particular section of cable, allowing for proactive maintenance before a failure occurs.

The AI system 204 may also analyze these image comparisons, using computer vision techniques to automatically detect and highlight areas of concern. This may include identifying visual patterns associated with different types of cable damage or degradation, such as changes in cable shape that might indicate bending or crushing, or changes in surface texture that might indicate wear or environmental damage.

By leveraging fiber sensing technology and AI, a comprehensive and real-time approach to cable installation inspection is achieved, ensuring the reliability and quality of the installed cable network. Real-time monitoring, high-loss point detection, strain monitoring, AI-based risk-assessment and alerts provide for a greater confidence that a cable system has maintained its integrity throughout its deployment/installation. The integrity of the cable installation process can include cable spool connections for deployment from a truck, ship, grounded spool or any other deployment configuration. The real-time monitoring can include features that can halt deployment (e.g., a cable installation halt mechanism) if damage or loss is detected. In such an instance, damage point localization can precisely locate the damage of lossy region of the cable to enable a a cable repair process.

The AI systems 204 described herein can include an Artificial Machine learning system that can be used to predict outputs or outcomes based on input data, e.g., fiber optic acoustic data. In an example, given a set of input data, a machine learning system can predict an outcome. The machine learning system will likely have been trained on much training data in order to generate its model. It will then predict the outcome based on the model.

While there is no need to label or extract source signals individually, the present systems can be employed to provide mixed labels for multiple vibrational sources as a substitute of single source class levels that would otherwise by employed to identify sound sources.

In some embodiments, the artificial machine learning system includes an artificial neural network (ANN). One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

The present embodiments may take any appropriate form, including any number of layers and any pattern or patterns of connections therebetween. ANNs demonstrate an ability to derive meaning from complicated or imprecise data and can be used to extract patterns and detect trends that are too complex to be detected by humans or other computer-based systems. The structure of a neural network is known generally to have input neurons that provide information to one or more “hidden” neurons. Connections between the input neurons and hidden neurons are weighted, and these weighted inputs are then processed by the hidden neurons according to some function in the hidden neurons. There can be any number of layers of hidden neurons, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. A set of output neurons accepts and processes weighted input from the last set of hidden neurons.

This represents a “feed-forward” computation, where information propagates from input neurons to the output neurons. Upon completion of a feed-forward computation, the output is compared to a desired output available from training data. The error relative to the training data is then processed in “backpropagation” computation, where the hidden neurons and input neurons receive information regarding the error propagating backward from the output neurons. Once the backward error propagation has been completed, weight updates are performed, with the weighted connections being updated to account for the received error. It should be noted that the three modes of operation, feed forward, back propagation, and weight update, do not overlap with one another. This represents just one variety of ANN computation, and that any appropriate form of computation may be used instead. In the present case the output neurons provide emission information for a given plot of land provided from the input of satellite or other image data.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output or target. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set or target, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight may be characterized as a weight value that is stored in a computer memory, and the activation function of each neuron may be implemented by a computer processor. The weight value may store any appropriate data value, such as a real number, a binary value, or a value selected from a fixed number of possibilities, which is multiplied against the relevant neuron outputs. Alternatively, the weights may be implemented as resistive processing units (RPUs), generating a predictable current output when an input voltage is applied in accordance with a settable resistance.

A neural network becomes trained by exposure to empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers because they are between the source nodes and output node(s) and are not directly observed. Each node in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

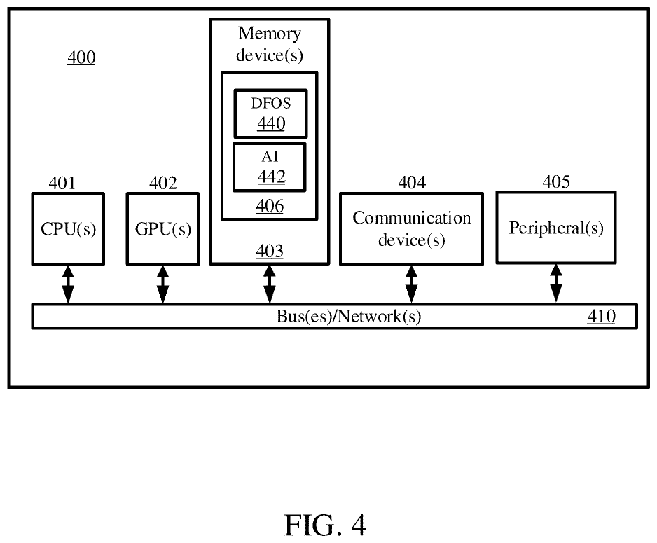

Referring to FIG. 4, a block diagram is shown for an exemplary processing system 400, in accordance with an embodiment of the present invention. The processing system 400 includes a set of processing units (e.g., CPUs) 401, a set of GPUs 402, a set of memory devices 403, a set of communication devices 404, and a set of peripherals 405. The CPUs 401 can be single or multi-core CPUs. The GPUs 402 can be single or multi-core GPUs. The one or more memory devices 403 can include caches, RAMs, ROMs, and other memories (flash, optical, magnetic, etc.). The communication devices 404 can include wireless and/or wired communication devices (e.g., network (e.g., WIFI, etc.) adapters, etc.). The peripherals 405 can include a display device, a user input device, a printer, an imaging device, and so forth. Elements of processing system 400 are connected by one or more buses or networks (collectively denoted by the figure reference numeral 410).

In an embodiment, memory devices 403 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 403 store program code for implementing one or more functions of the systems and methods described herein for programmed software 406. The memory devices 403 can store program code for implementing one or more functions of the systems and methods described herein. The software 406 can include a DFOS system interrogation system 440 and AI system 442, among other programs and functions.

Of course, the processing system 400 may also include other elements (not shown), as readily contemplated by one of skill in the art, as well as omitting certain elements. For example, various other input devices and/or output devices can be included in processing system 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 400 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 400.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

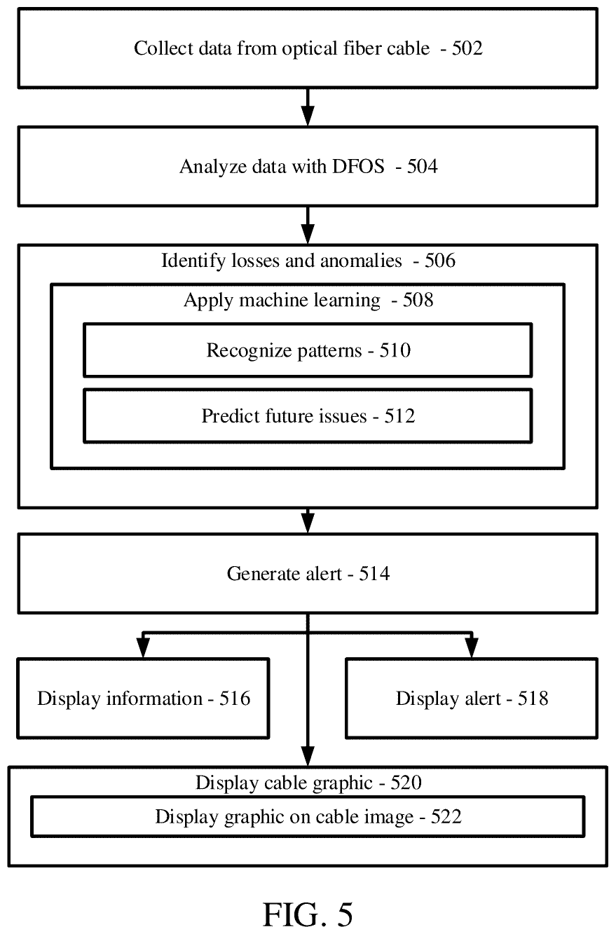

Referring to FIG. 5, systems and computer-implemented methods for cable inspection and monitoring using optical fiber sensing are described and shown in accordance with embodiments of the present invention. In block 502, data is collected from a fiber optic cable. In block 504, the data is analyzed with a distributed fiber optic sensing (DFOS) system. The DFOS system can include one or more of a Distributed Acoustic Sensing (DAS) system, a Distributed Vibration Sensing (DVS) system, or a Brillouin Optical Time Domain Reflectometry (BOTDR) system. The DFOS system can provide precise locations where issues are detected within the cable. In block 506, losses and anomalies in the cable are identified. In block 508, the losses and anomalies can be identified in the cable by applying machine learning to identify patterns in the data. In block 510, the machine learning can include a neural network trained to recognize specific patterns associated with cable degradation. In block 512, the machine learning can predict future losses and anomalies in the cable.

In block 514, an alert can be generated based on the losses and anomalies. In block 516, information about the losses and anomalies can be displayed on a user interface. In block 518, the alert or alerts can be displayed on a user interface.

In block 520, the losses and anomalies can be graphically shown on a depiction of a cable. In block 522, the losses and anomalies can be graphically shown overlaid on an image of the cable.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A system for cable inspection using optical fiber sensing, comprising:
a hardware processor; and
a memory storing a computer program which, when executed by the hardware processor, causes the hardware processor to:
collect data from a fiber optic cable;
analyze the data with a distributed fiber optic sensing (DFOS) system;
identify losses and anomalies and their locations in the fiber optic cable; and
generate an alert based on the losses and anomalies.

2. The system of claim 1, wherein the DFOS system includes one or more of a Distributed Acoustic Sensing (DAS) system, a Distributed Vibration Sensing (DVS) system, or a Brillouin Optical Time Domain Reflectometry (BOTDR) system.

3. The system of claim 1, wherein the computer program further causes the hardware processor to display information about the losses and anomalies on a user interface.

4. The system of claim 1, wherein the computer program further causes the hardware processor to display the alert on a user interface.

5. The system of claim 1, wherein the computer program further causes the hardware processor to identify losses and anomalies by applying machine learning to identify patterns in the data.

6. The system of claim 5, wherein the machine learning includes a neural network trained to recognize specific patterns associated with cable degradation.

7. The system of claim 6, wherein the neural network is trained on a dataset that includes different types of fiber losses and failure modes.

8. The system of claim 5, wherein the machine learning predicts future losses and anomalies in the fiber optic cable.

9. The system of claim 1, wherein the computer program further causes the hardware processor to graphically display the losses and anomalies on a cable.

10. The system of claim 9, wherein the computer program further causes the hardware processor to display cable images graphically showing the losses and anomalies overlaid on an image of the cable.

11. A computer-implemented method for cable inspection using optical fiber sensing, comprising:
collecting data from a fiber optic cable;
analyzing the data with a distributed fiber optic sensing (DFOS) system;
identifying losses and anomalies and their locations in the fiber optic cable; and
generating an alert based on the losses and anomalies.

12. The method of claim 11, wherein the DFOS system includes one or more of a Distributed Acoustic Sensing (DAS) system, a Distributed Vibration Sensing (DVS) system, or a Brillouin Optical Time Domain Reflectometry (BOTDR) system.

13. The method of claim 11, further comprising displaying information about the losses and anomalies on a user interface.

14. The method of claim 11, further comprising displaying the alert on a user interface.

15. The method of claim 11, wherein identifying losses and anomalies includes applying machine learning to identify patterns in the data.

16. The method of claim 15, wherein the machine learning includes a neural network trained to recognize specific patterns associated with cable degradation.

17. The method of claim 15, wherein the machine learning predicts future losses and anomalies in the fiber optic cable.

18. The method of claim 11, further comprising graphically showing the losses and anomalies on a cable.

19. The method of claim 18, further comprising graphically showing the losses and anomalies overlaid on an image of the fiber optic cable.

20. A computer program product, the computer program product comprising a computer readable storage medium storing program instructions embodied therewith, the program instructions executable by a hardware processor to cause the hardware processor to:
collect data from a fiber optic cable;
analyze the data with a distributed fiber optic sensing (DFOS) system;
identify losses and anomalies and their locations in the fiber optic cable; and
generate an alert based on the losses and anomalies.
